(19) United States
(12) Patent Application Publication
(10) Pub. No.: US 2017/0287304 A1
(43) Pub. Date: Oct. 5, 2017

(54) CHILD CARE COMMUNICATION DEVICE & SYSTEM

(71) Applicants: KRISTINE VREDEVELD, CINCINNATI, OH (US); CAMILLE GARTNER, CINCINNATI, OH (US)

(72) Inventors: KRISTINE VREDEVELD, CINCINNATI, OH (US); CAMILLE GARTNER, CINCINNATI, OH (US)

(21) Appl. No.: 13/846,846

(22) Filed: Mar. 18, 2013

(51) Int. Cl. G08B 21/02

(52) U.S. Cl. CPC G08B 21/0288; G08B 25/016

(57) ABSTRACT

The invention herein provides a child care and transportation communication system and child care activity device therefor. More specifically, a device is provided that is attachable to a child's person, most preferably a back pack, from which a child's activity or transportation is immediately known so that such child is properly escorted and/or cared for either before school or after school.

### FIELD OF THE INVENTION

The invention herein provides a child care and transportation communication system and child care activity device therefor. More specifically, a device is provided that is attachable to a child's person, most preferably a back pack, from which a child's activity or transportation is immediately known so that such child is properly escorted and/or cared for either before school or after school.

### BACKGROUND OF THE INVENTION

Today's children are busier than ever. In many cases their schedules can be as complex as their parents. Such busyness begins earlier and earlier in the life of many children, even from pre-school as parents seek opportunities and enrichment of their children.

Facilitating organization of such busy schedules are the legions of responsible adults who serve as teachers and child care professionals who carry responsibility for the travel and whereabouts of their young charges. Easy and immediate knowledge of a child's next travel and/or arrangements is critical to prevent loss.

In the busyness of end-day dismissal, teachers and teaching assistants must quickly and accurately assess the travel arrangements and/or after school activity of their children. This often happens via some form of communication like email, notes from home, a phone call and the like. However, these communications can be forgotten, mis-placed or mis-interpreted.

What is therefore required is a communication system that enables adults responsible for children, and in particular children's transitions for travel or activity, to know upon sight where a child is supposed to be and with whom. The foregoing discussion, examples and claims make clear the metes and bounds of that system.

### SUMMARY OF THE INVENTION

Accordingly, the present invention provides a child care activity device, comprising an attachment device attachable to a child's person and at least one activity icon attachable to said attachment device, said at least one activity icon vividly communicating an activity at which said child should attend.

In practice, the child care activity device is attachable to a child's coat, back pack, or book bag.

The child care activity device comprises two or more activity icons. For example, an activity icon herein comprises a message may consist of information related to transportation, bus riding, car riding (e.g., via car line or pick up), bike riding, walking, before or after school care, or any of a number of after school activities attended by a child. Also communicated are messages relating to a child's activities: e.g., sports, the arts, and any extra curricular activity before or after school.

The activity icons herein comprise at least one bright distinguishable color wherein the color is assignable to one activity. Also, the activity icons herein comprise at least one image of a character. Typically, only one activity is shown at a time on one child care activity device. This character denotes a specific activity.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 provides a plane view of an activity icon herein;

FIG. 2 shows the activity icon and attachment device attached to the back of a child's back pack;

FIGS. 3-8 are planar views of multiple icons for use in the system and device herein;

FIG. 9 shows multiple activity icons shown on hook in a displayed configuration; and

FIG. 10 shows the multiple activity icons of FIG. 9 in side view whereby the activity icons are nested one behind the other.

### DETAILED DESCRIPTION

The present invention provides a child care activity device, comprising an attachment device attachable to a child's person and at least one activity icon attachable to said attachment device, said at least one activity icon vividly communicating an activity at which said child should attend. Such “care” in the child care activity device covers any and all possible, responsible care and activity that a child can engage.

In practice, the child care activity device is attachable to a child's coat, back pack, or book bag. If attached to a coat, the preferred attachment thereto is to the front of the coat. If attached to a book bag, the preferred attachment is at the discretion of the parent or other responsible adult. For example, if a child is between the ages of about 2-5 years old, it may be preferred to attach the child care activity device to the backward facing surface of the child's backpack. This prevents unwanted manipulation or loss of the child activity device by the child. Since such device is brightly colored and preferably pliable, it would be wise to limit such a child's access thereto. In the instance in which a child is age 6-10, a parent may consider placement of the child care activity device on a front strap of the child's backpack. This is at the parent's discretion but also dependent upon the development and functional maturity of the child. The critical element here is unobstructed viewing and thereby communication of the child care activity device.

The child care activity device comprises two or more activity icons. For example, an activity icon herein comprises a message may consist of information related to transportation, bus riding, car riding (e.g., via car line or pick up), bike riding, walking, before or after school care, or any of a number of after school activities attended by a child. Also communicated are messages relating to a child's activities: e.g., sports, the arts, and any extra curricular activity before or after school.

The activity icons herein comprise at least one bright distinguishable color wherein the color is assignable to one activity. Also, the activity icons herein comprise at least one image of a character. Typically, only one activity is shown on one child care activity device. This character denotes a specific activity.

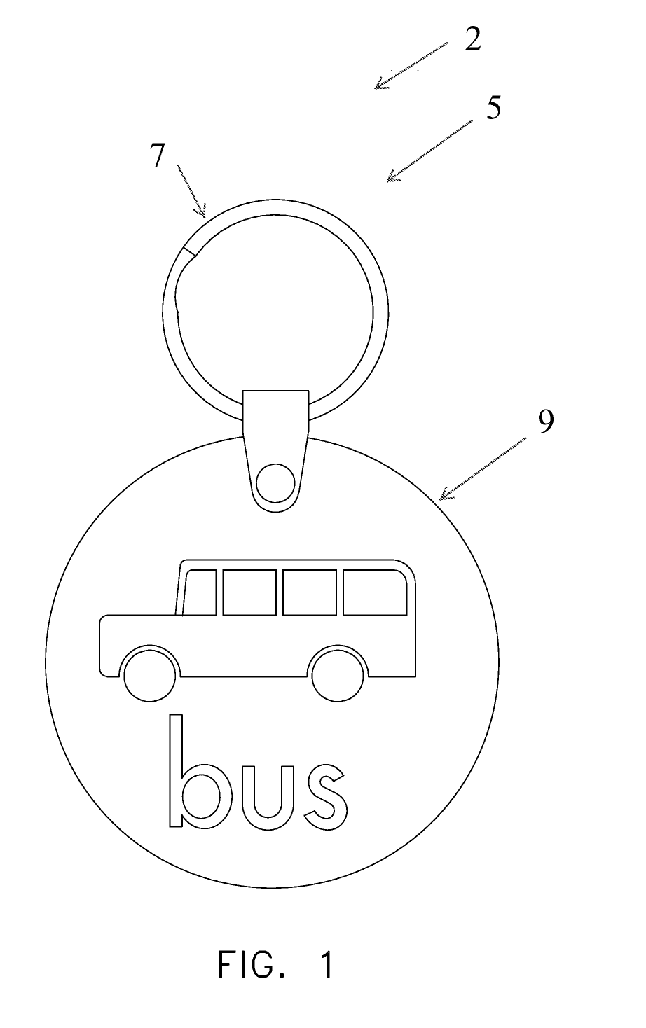

FIG. 1 provides a plane view of an activity icon 5 herein for use in a child care communication device 1 herein (not shown). The activity icon 5 shown includes two main parts; i.e., loop 7 and icon 9. Icon 9 shown is, preferably, a pliable, i.e., soft, disc that indicates an activity to which a child wearing activity icon 5 shall attend. In this instance, a child wearing activity icon 9 shall be assigned to the proper location after school to board his bus home. Also, activity icon 9 is preferably very brightly colored so that immediate recognition may occur. This is important because a child wearing such activity icon 5 may be unable to properly communicate or remember where he or she is supposed to be after school.

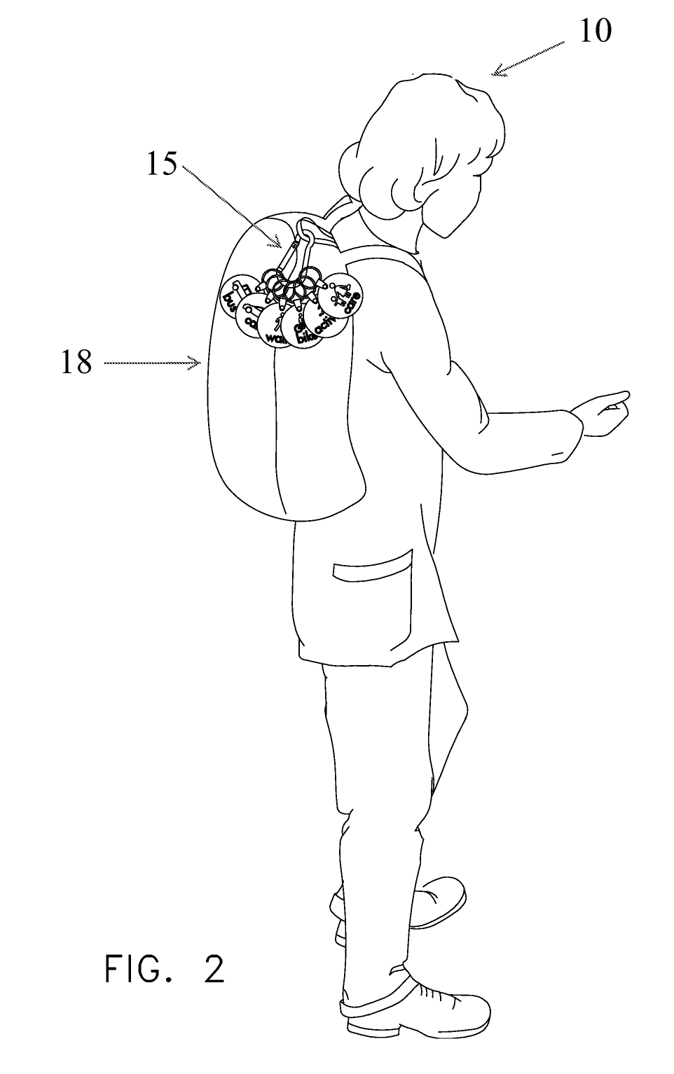

FIG. 2 provides a realistic portrayal of the use of the child care activity system 15 for communication of a child's activity. As shown, system 15 is attached to the back of child 10's back pack 18. Multiple activity icons 5 are shown displayed for affect, but in use activity icons 5 would be stacked one behind the other such that only the top and relevant activity icon 5 would be viewable.

Child care activity system 15 is designed to be viewable by responsible adults who have responsibility for placement of children after school. Activity icons 5 thereon are designed to be brightly colored with pictorials on each that are easily and discernibly recognized from twenty feet or less. Such easy, ready recognition facilitates child placement and care in as mistake-free a manner as is possible.

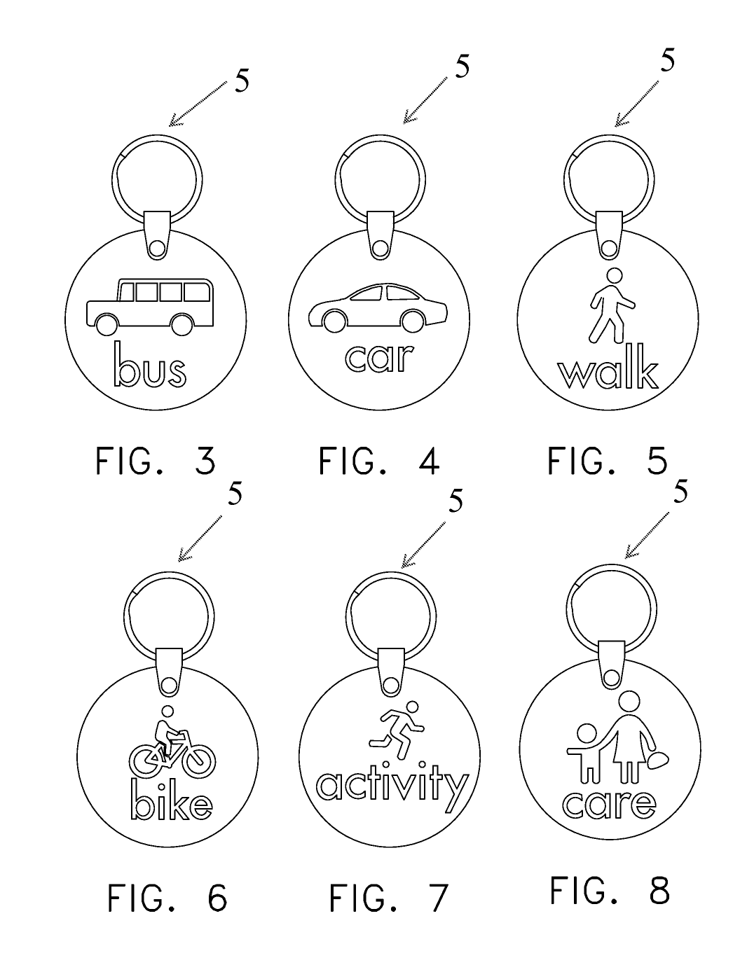

FIGS. 3-8 show various activity icons 5 with various activities thereon. For example, FIG. 3 shows a bus icon. FIG. 4 shows a car icon for child travel by car after school. FIG. 5 shows a walking icon for child travel as a walker after school. FIG. 6 shows a biking icon for child travel as a biker after school. FIG. 7 shows a sports icon for a child participating in a sport like soccer, football, and the like after school. FIG. 8 shows a child care icon by which a child goes to an after school child care environment upon dismissal.

Of course, a manufacturer may add activity icons 5 of the type and kind most appropriate for a given market. For example, activity icons 5 denoting early dismissal from school can be made. Also, activity icons 5 that denote activities such as doctor appointments, dental appointments and the like can be added. Key criteria for any and all activity icons 5 of the kind discussed herein should be 1) that the characters thereon are clearly and immediately discernible and recognizable at thirty feet or less; 2) that bright colors are used; and 3) that materials used are non-injurious to children either due to hardness or to size.

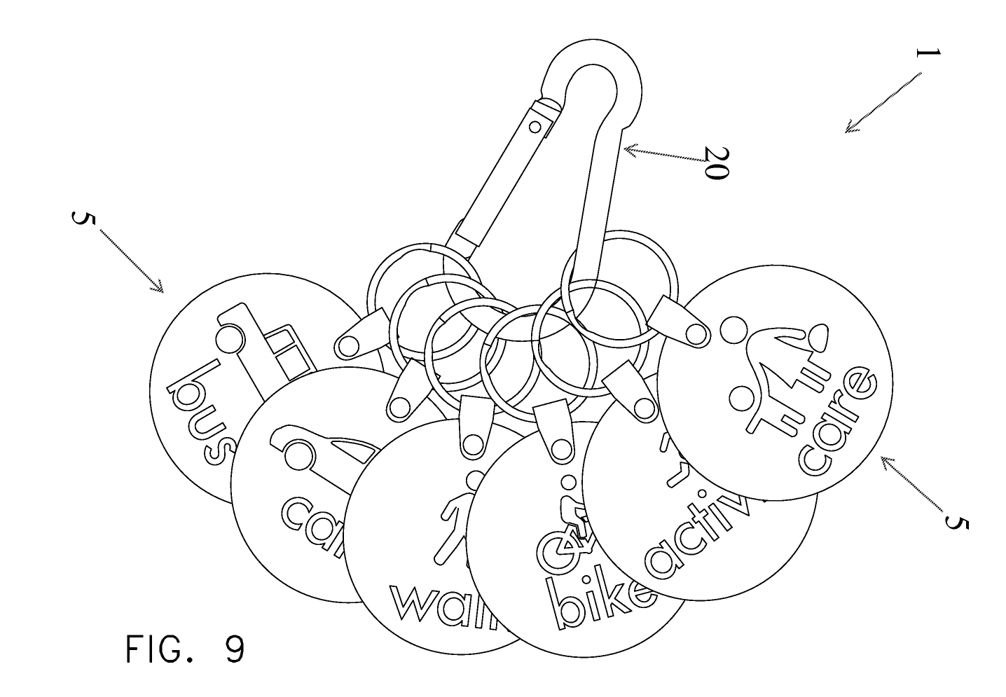

FIG. 9 provides a child care communication device 1 for use in the child care activity system 15 for communication of a child's activity. Activity icons 5 are connected by their loops 7 to hook 20. Hook 20 may be made from a variety of materials. Whichever materials are used, they must be durable and resistant to breakage in normal use of child communication device 1. Preferably, hook 20 is metal, steel or aluminum, or any of a number of known alloys. Hook 20 may also be constructed from break resistant plastic, e.g., hardened polypropylene, polyethylene and the like.

FIG. 10 provides a side view of child care communication device 1 of FIG. 9. When more than one activity icon 5 is attached to hook 20, activity icons 5 rest or nest upon each other as shown herein. Though FIG. 10 shows activity icons 5 displayed in a fanned configuration, their actual configuration is that shown in FIG. 9 especially as they are connected to a child or child's back pack 18.

Activity icons 5 herein can be made from a variety of materials including but not limited to rubber, polyethylene, polypropylene, vinyl, wood, metal, combinations thereof and others. Preferably, the material used is soft and non-injurious to a child and others. A softened vinyl, rubber or other material from the family of plastics as noted hereinabove are preferred.

### Example I

In but one example herein, the child care activity device 2 consists of a variety of activity icons 5 and an attachable hook 20. As noted hereinabove, the attachable hook 20 is suitable for placement of one or more activity icons thereon and to a suitable surface of a child's clothing or bag, most preferably a book bag.

In this instance as a parent prepares his child for travel to school in the morning, the parent applies only one activity icon to the attachable hook. The parent determines that his daughter, instead of her more normal schedule of travel home by bus, will instead remain after school for a drama activity. The parent therefore applies the drama activity icon (or an activity icon that clearly communicates an after school activity) to the attachable hook 20 and then attaches the combination to the backward facing surface of his daughter's book bag so that it is clearly discernible by a caregiver.

The activity icon for an after school activity is brightly colored and clearly marked to indicate the nature of this child's most immediate required whereabouts after school. When she is prepared to transition from her teacher's classroom, her teacher and/or assistants will recognize this child's next responsible locale and safely transition her thereto.

### Example II

In another example herein, a young child's child care activity device 2 is attached to a front ward strap of his book bag (or other suitable carrier) which he knows to wear at all times between home and school and back again.

His parents have attached two or more activity icons to his attachable hook. Further, they have placed the activity icon that communicates their son's current day activity on the front of the activity icon bundle.

This child has four separate activities for the week. His attachable hook contains all activities at once. Before he leaves his home, one of this child's parents selects that day's activity and places it first on his attachable hook so that it is the only activity icon viewable.

All of the adults responsible for this child's care are well versed in this child's communication system and immediately recognize the activity icon for that day, understanding his required whereabouts of that day. On this day, the child is required to be in car line for a car ride home by one of his parents.

As in the previous example, the activity icon for an after school activity is brightly colored and clearly marked to indicate the nature of this child's most immediate required whereabouts after school. When she is prepared to transition from her teacher's classroom, her teacher and/or assistants will recognize this child's next responsible locale and safely transition her thereto.

1. A child care activity device, comprising:
a. An attachment device attachable to a child's person;
b. At least one activity icon attachable to said attachment device, said at least one activity icon vividly communicating an activity at which said child should attend.

2. The child care activity device of claim 1 wherein said child care activity device is attached to said child's coat.

3. The child care activity device of claim 1 wherein said child care activity device is attached to said child's book bag.

4. The child care activity device of claim 1 wherein said device comprises one or more activity icons.

5. The child care activity device of claim 1 wherein said activity icon comprises a message consisting of related to transportation, bus rider, car rider, bike rider, walker, before or after school care, or any of a number of after school activities attended by said child.

6. The device of claim 1 wherein said icon comprises a message related to a child's activities: sports, the arts, and any extra curricular activity before or after school.

7. The child care activity device of claim 1 wherein said activity icon comprises at least one bright distinguishable color, wherein said color is assignable to one activity.

8. The child care activity device of claim 1 wherein said activity icon comprises at least one image.

9. The child care activity device of claim 7 wherein said at least one character denotes a specific activity.

10. The child care activity device of claim 1 wherein said activity icon is readily recognizable by a one or more persons responsible for said child.

11. A child care activity device, comprising:
a. An attachment device attachable to a child's backpack;
b. At least one activity icon attachable to said attachment device, said at least one activity icon vividly communicating an activity at which said child should attend.

12. The child care activity device of claim 11 wherein said device comprises two or more activity icons.

13. The child care activity device of claim 11 wherein said activity icon comprises a message consisting of related to transportation, bus rider, car rider, bike rider, walker, before or after school care, or any of a number of after school activities attended by said child.

14. The device of claim 11 wherein said icon comprises a message related to a child's activities: sports, the arts, and any extra curricular activity before or after school.

15. The child care activity device of claim 11 wherein said activity icon comprises at least one bright distinguishable color, wherein said color is assignable to one activity.

16. The child care activity device of claim 11 wherein said activity icon comprises at least one image.

17. The child care activity device of claim 16 wherein said at least one character denotes a specific activity.

18. The child care activity device of claim 11 wherein said activity icon is readily recognizable by a one or more persons responsible for said child.

19. A child care activity communication system, comprising:
a. A child care activity device, having:
i. An attachment device attachable to a child's person; and
ii. At least one activity icon attachable to said attachment device, said at least one activity icon vividly communicating an activity at which said child should attend.
